(19) United States
(12) Patent Application Publication
(10) Pub. No.: US 2010/0219707 A1
(43) Pub. Date: Sep. 2, 2010

(54) Electric motor

(76) Inventor: Eric Nadeau, Terrebonne (CA)

Correspondence Address: Louis Tessier, C.P. 54029, Mount-Royal, H3P 3H4, CA

(21) Appl. No.: 12/656,100

(22) Filed: Jan. 15, 2010

Related U.S. Application Data
(60) Provisional application No. 61/193,982, filed on Jan. 15, 2009.

(51) Int. Cl. H02K 16/00

(52) U.S. Cl. 310/112

(57) ABSTRACT

An electric motor, said electric motor comprising: a motor first section, said motor first section including a first section stator, said first section stator including a plurality of coils disposed in a substantially annular configuration therearound, and a first section rotor, said first section rotor including a plurality of permanent magnets disposed in a substantially annular configuration therearound, said first section rotor being rotatable with respect to said first section stator; a motor second section, said motor second section including a second section stator, said second section stator including a plurality of coils disposed in a substantially annular configuration therearound, and a second section rotor, said second section rotor including a plurality of permanent magnets disposed in a substantially annular configuration therearound, said second section rotor being rotatable with respect to said second section stator; said first and second section rotors being substantially coaxial and facing each other, said first and second section rotors being rotatable independently from each other; said first and second section rotors being magnetically coupled to each other so that a rotation of a first one of said first and second section rotors causes a rotation of the other one said first and second section rotor.

This application claims priority from U.S. Provisional Patent Application Ser. No. 61/193,982 filed Jan. 15, 2009.

### FIELD OF THE INVENTION

The present invention relates generally to electric motors.

### BACKGROUND

There is an increasing interest in the automotive industry for electric motor propulsion. Since automotive applications are by definition mobile, the motors used in such applications are powered by batteries. Battery power causes numerous constraints to electric vehicles. For example, because of the relatively low power density of batteries, there is a need to have relatively efficient electric motors in these applications. Also, high power density batteries are relatively costly, and, in some applications, represent a significant portion of the manufacturing cost of an electric vehicle. Therefore, using relatively sophisticated electric motors that would be more efficient could result in lower cost vehicles, even if these motors are more expensive because of this sophistication.

Another problem common to many electric motors resides in a particularly unfriendly failure modes. Indeed, many such motors will fail totally or produce insignificant output in case of failure. This characteristic is undesirable in electric vehicles as it may lead to safety issues if failure occurs while the vehicle is moving.

Another problem resides in that in electric vehicles, it is often advantageous to add a single motor. However, to allow the wheels of the vehicle to move at different speeds, there is a need to add a differential between the motor and the wheels, which reduces efficiency.

Against this background, there exists a need in the industry to provide an improved electric motor.

An object of the present invention is therefore to provide an improved electric motor.

### SUMMARY OF THE INVENTION

In a broad aspect, the invention provides an electric motor, the electric motor comprising: a plurality of stators, the stators being substantially coaxial relatively to each other and substantially axially spaced apart from each other, each of the stators including a plurality of coils disposed in a substantially annular configuration therearound; a plurality of internal rotors, the internal rotors being substantially coaxial relatively to each other, each of the rotor being inserted between two of the stators, each of the internal rotors including a plurality of permanent magnets disposes in a substantially annular configuration therearound; two end rotors, the end rotors being substantially coaxial relatively to the internal rotors, the plurality of stators and the plurality of rotors being located between the two end rotors, each of the end rotors including a plurality of permanent magnets disposes in a substantially annular configuration therearound; and an axle, the axle being mechanically coupled to at least one of the end rotors and to at least one of the internal rotors so that the at least one of the end rotors and the least one of the internal rotors are substantially jointly rotatable about the axle.

Advantageously, the presence of the two end of rotors maximizes the efficiency of the proposed motor as coil magnetic field leaks outside of the motor are minimized.

In some embodiments of the invention, the coils of adjacent stators are circumferentially offset from each other. In these embodiments, having rotors with aligned permanent magnets allows for relatively easily controlling the sequence of powering of the adjacent stators. In addition, this structure creates a multiphase motor that increases the reliability of the motor as a failure of one of the stators only slightly decreases the power output by the motor.

In some embodiments of the invention, the coils are coreless made out of two coil sections disposed substantially adjacent to each other with their input and output wires at the middle of the coils. This configuration of the coils facilitates the wiring of the proposed motor and allows for selectively powering the two coil sections in series or in parallel. In addition, coreless coils eliminate polarization losses created in ferromagnetic cores.

In other embodiments of the invention, the coils are also coreless and made out of substantially continuous insulated electrical wire, and they include each a coil first section and a coil second section. The coil first and second sections define respectively a first section coil end to which electrical power can be provided and a second section coil end to which electrical power can be provided. The first and second section coil ends are located radially outwardly with respect to the coil. The coil is devoid of any substantially radially extending wire section.

Due to its high-efficiency, the proposed motor is relatively easily cooled, and the structure of the motor allows for easily cool the motor using a gas or a liquid.

The modular nature of the proposed motor allows for relatively easily increasing the power of the motor by increasing the number of rotors and stators. In addition, the use of a number of substantially identical modules creates economies of scale and ease of assembly.

In another broad aspect, the invention provides an electric motor, the electric motor comprising: a motor first section, the motor first section including a first section stator, the first section stator including a plurality of coils disposed in a substantially annular configuration therearound, and a first section rotor, the first section rotor including a plurality of permanent magnets disposed in a substantially annular configuration therearound, the first section rotor being rotatable with respect to the first section stator; a motor second section, the motor second section including a second section stator, the second section stator including a plurality of coils disposed in a substantially annular configuration therearound, and a second section rotor, the second section rotor including a plurality of permanent magnets disposed in a substantially annular configuration therearound, the second section rotor being rotatable with respect to the second section stator; the first and second section rotors being substantially coaxial and facing each other, the first and second section rotors being rotatable independently from each other; the first and second section rotors being magnetically coupled to each other so that a rotation of a first one of the first and second section rotors causes a rotation of the other one the first and second section rotor.

In some embodiments, each of the motor first and second sections includes more than one rotor and/or more than one stator.

In applications in which two wheels are connected to a single motor, having two axles in the motor, each connected to a respective one of the first and second section rotors, creates an independence between the two wheels which can then have a difference in rotation speed without requiring a differential. The magnetic coupling provides limited slip between the two motor sections.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawing:

FIG. 1, in a side cross-section, illustrates and electric motor in accordance with an embodiment of the present invention;

FIG. 2, in a side cross-section view, illustrates a stator and a pair of rotors of the electric motor shown in FIG. 1;

FIG. 3, in a perspective exploded view, illustrates the stator and rotors shown in FIG. 2;

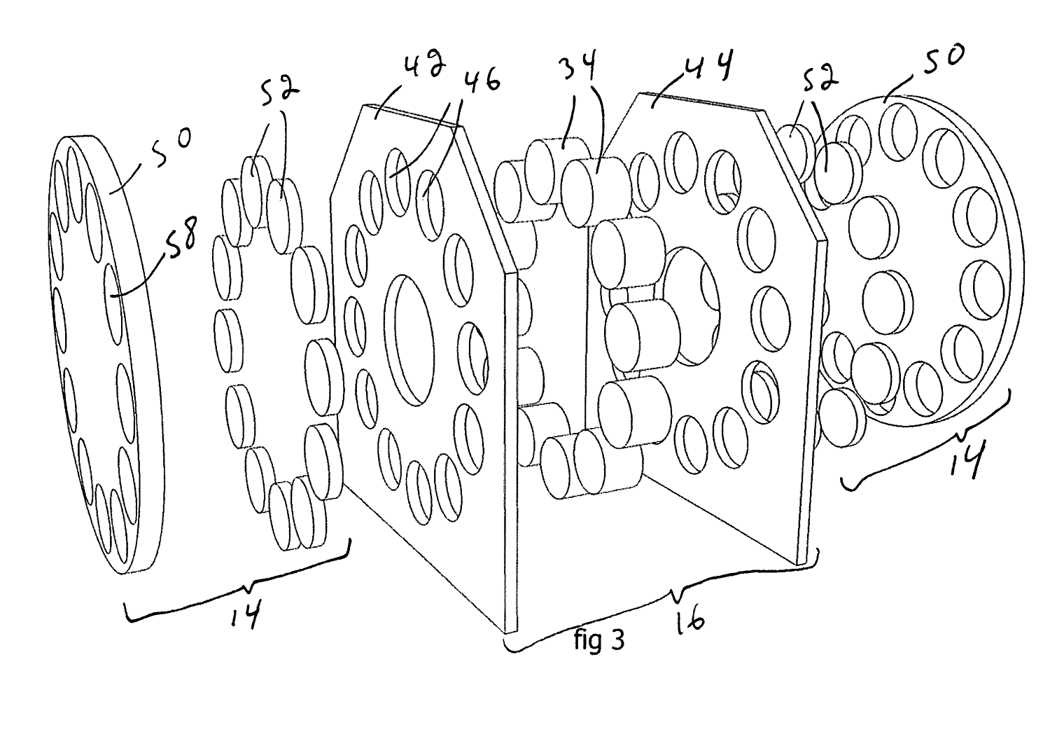

FIG. 4, in a front elevation view, illustrates one of the stators shown in FIGS. 2 and 3;

FIG. 5, in a front elevation view, illustrates one of the rotors shown in FIGS. 2 and 3;

FIG. 6, in a schematic view, illustrates a control system for controlling the electric motor shown in FIGS. 1 to 5

FIG. 7, in a schematic view, illustrates a wiring diagram for the coils of the stator shown in FIG. 4;

FIG. 8, in a partial exploded view, illustrates an electric motor in accordance with an alternative embodiment of the present invention;

FIG. 9, in a perspective cross-sectional view, illustrates a stator of the electric motor shown in FIG. 8;

FIG. 10, in a perspective view, illustrates a coil of the stator shown in FIG. 9 mounted on a mandrel used to manufacture the coil;

FIG. 11, in a perspective view, illustrates the mandrel used to manufacture the coil shown in FIG. 10; and

FIG. 12, in a perspective partially exploded view, illustrates the mandrel shown in FIG. 11.

### DETAILED DESCRIPTION

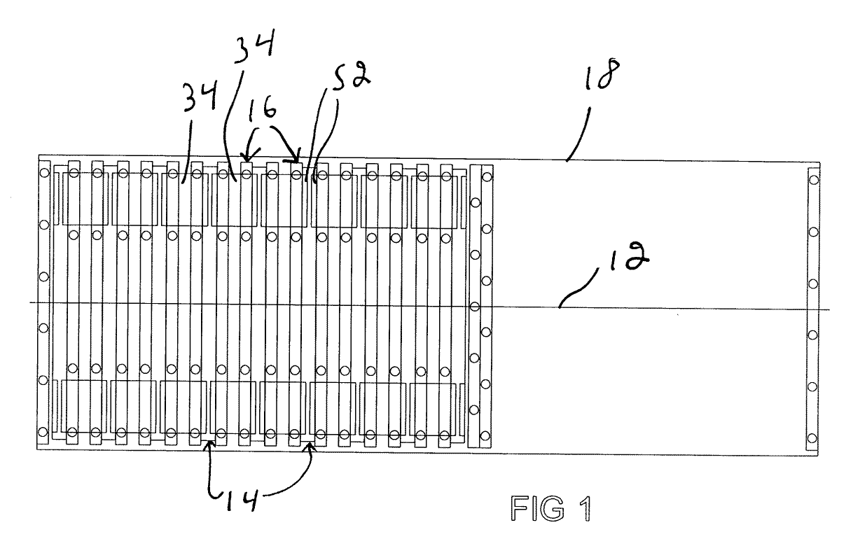

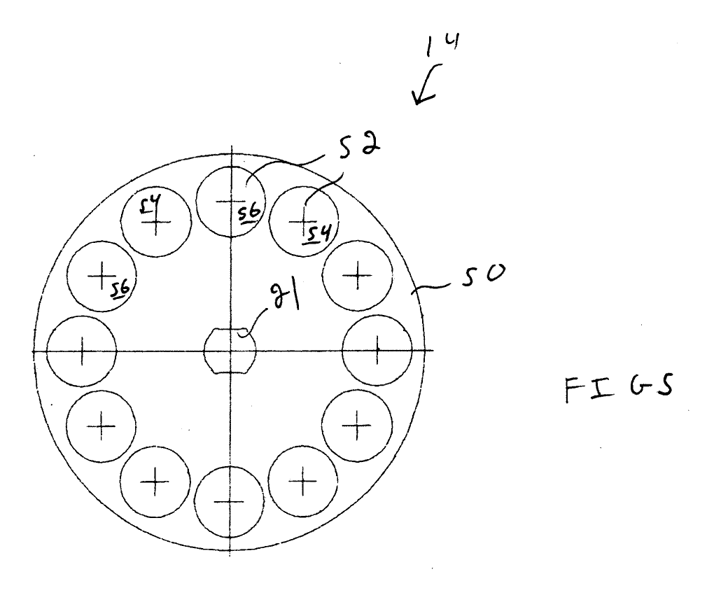

With reference to FIG. 1, there is shown and electric motor 10 in accordance with an embodiment of the invention. The electric motor 10 defines a motor longitudinal axis 12. The electric motor 10 includes a plurality of substantially coaxial stators 16. The stators 16 are substantially axially spaced apart from each other. The electric motor 10 also includes a plurality of substantially coaxial rotors 14. The rotors 14 are divided into internal rotors 14 and end rotors 14. Each of the internal rotors 14 is inserted between two of the stators 16. The stators 16 and the internal rotors 14 are located between the two end rotors 14. The rotors 14 and the stators 16 are mounted inside a casing 18. An axle 20 is mechanically coupled to at least the one of the end rotors 14 and at least one of the internal rotors 14 so that the rotors 14 that are mechanically coupled to the axle 20 are substantially jointly rotatable therewith about the motor longitudinal axis 12. For example, the rotors 14 define an aperture 21 (better seen in FIG. 5) extending longitudinally therethrough for receiving the axle 20 substantially snugly.

In some embodiments of the invention, a single axle 20 is mechanically coupled to all the rotors 14. However, in alternative embodiments of the invention, two axles 20 are provided, half of the rotors 14 being mechanically coupled to one of the axles and the other half of the rotors 14 being mechanically coupled to the other axle 20. In this embodiment, the two axles 20 may rotate at different speeds and therefore eliminate the need for a differential between the two axles 20 in automotive applications. Also, in this embodiment, it may be advantageous for symmetry reasons to have two substantially adjacent rotors 14 in the middle of the electric motors 10, each of these adjacent rotors being attached to a respective axle 20. This embodiment is discussed in further details hereinbelow.

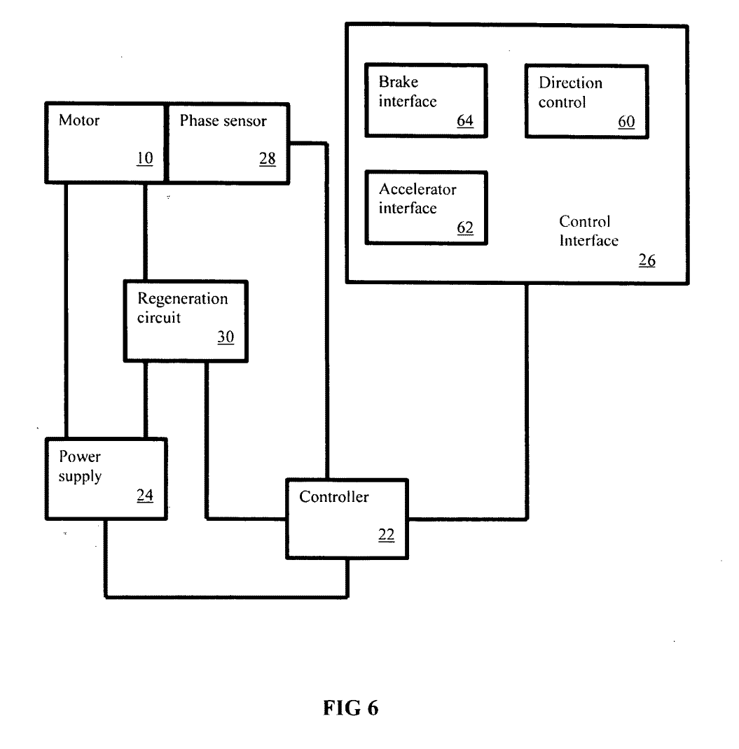

In the embodiment of the invention shown in the drawings, the stators 16 are provided with coils 34 that are electrically powered to create electromagnets. The coils 34 all have their longitudinal axis substantially parallel to the motor longitudinal axis 12. The rotors 14 are provided with permanent magnets 52 that interact with the coils 34 to rotate the rotors 14. The permanent magnets 52 have their magnetic axes substantially parallel to each other and to the motor longitudinal axis. As seen in FIG. 6, a controller 22 is connected to a power supply 24 and to a control interface 26 for powering the coils 34 in sequence through the power supply 24 in response to signals received from the control interface 26. In some embodiments of the invention, a phase sensor 28 is operatively coupled to the electric motor 10 for providing to the controller 22 a signal indicative of the angular position of the rotors 14. Also, in some embodiments of the invention, a regeneration circuit 30 is provided for recovering energy when external forces rotate the rotors 14 relatively to the stators 16.

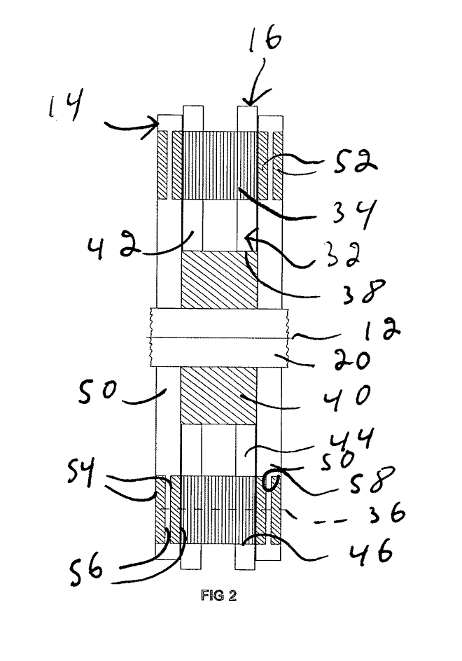

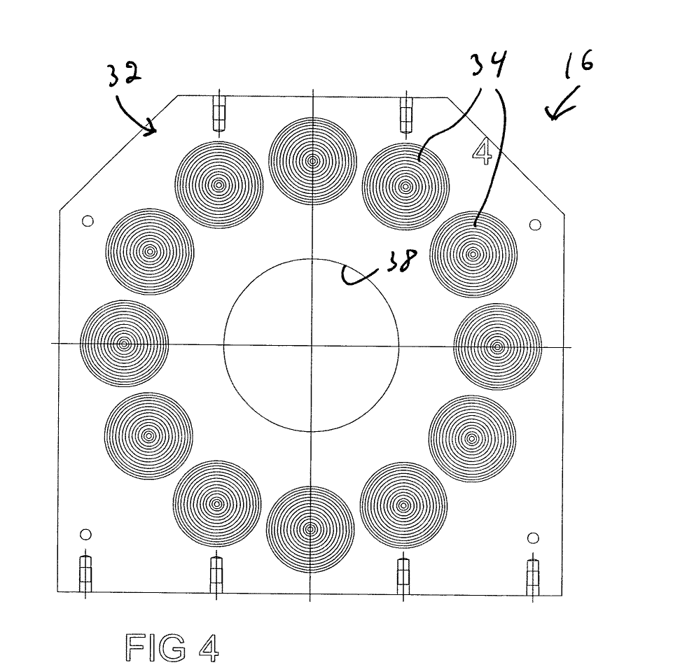

As seen for example in FIG. 4, each of the stators 16 is fixedly mounted to the casing 18 and includes a stator body 32. The coils 34 are mounted to the stator body 32 and disposed in a substantially annular configuration around the motor longitudinal axis 12. Each of the coils 34 defines a coil longitudinal axis 36, seen in FIG. 2, that extends substantially parallel to the motor longitudinal axis 12. In some embodiments of the invention, the coils 34 are coreless so as to eliminate polarization losses.

A central aperture 38 substantially coaxial with the motor longitudinal axis 12 extends through the stator body 32. A bearing 40 is provided in the central aperture 38 and the axle 20 is mounted to the bearing 40 as to be substantially freely rotatable about the motor longitudinal axis 12.

The stator body 32 includes a first plate 42 and a second plate 44, the first and second plates 42 and 44 being in a substantially parallel and longitudinally spaced apart relationship relatively to each other. The first and second plates 42 and 44 each define a plurality of recesses 46 each provided for receiving a portion of one of the coils 34. In the embodiment of the invention shown in the drawings, each of the recesses 46 extends only partially through the first and second plates 42 and 44. The recesses 46 provided in the first plate 42 are each substantially register with a corresponding recess 46 provided in the second plate 44, these two recesses 46 facing each other. Each of the coils 34 is mounted inside two recesses 46 substantially in register with each other and is therefore maintained in between the first and second plates 42 and 44. fasteners 46 secure the first and second plates 42 and 44 to each other. For example, the fasteners 46 include conventional nuts and bolts inserted through apertures provided in first and second plates 42 and 44.

The coils 34 in adjacent stators 16 are offset angularly relatively to each other. This offset in subsequent stators 16 is such that stators 16 spaced apart by a predetermined number of stators 16 have substantially similar coil angular configurations. This predetermined number determines the number of phases used in the electric motor 10.

Each rotor 14 includes a rotor body 50 to which magnets 52 are mounted. The magnets 52 are mounted in a substantially annular configuration around the motor longitudinal axis 12. Each of the magnets 52 defines a north pole 54 and a south pole 56. An axis extending between the north and south poles 54 and 56 of each magnet 52 is substantially parallel to the motor longitudinal axis 12. In the embodiment of the invention shown in the drawings, the magnets 52 provided in all the rotors 14 are substantially in phase, or, in other words, substantially aligned with each other between rotors 14.

The rotor body 50 defines recesses 58 extending substantially longitudinally thereinto, each of the recesses 58 being provided for receiving one of the magnets 52. In some embodiments of the invention, the rotor body 50 is substantially plate shaped and defines substantially in register recesses 58 on opposite surfaces of the rotor body 50, each of the recesses extending substantially inwardly into the rotor body 50. Magnets 52 provided in substantially opposed recesses 58 have their polarity aligned such that they attract each other and frictionally engage the rotor body 50 to reduce the forces exerted by the magnets 52 onto the rotor body 50 as the rotors 14 rotate.

Therefore, the material used to manufacture the rotor body 50 does not need to be extremely strong as the total abutment centrifugal force exerted on the periphery of the recesses 58 of the rotor body 50 in the radial direction is relatively weak. The rotor body 50 is made out of a nonmagnetic material, such as, for example, aluminum. FIG. 5 illustrates some of the above-describes features of the rotors 16.

Referring to FIG. 6, there is a show in greater details the control interface 26. The control interface 26 includes a direction control 60 controlling the direction of rotation of the motor 10. An accelerator interface 62, for example a conventional accelerator pedal, allows for indicating the amount of power that should be provided to the motor 10. A brake interface 64, such as for example a conventional brake pedal, is provided for indicating that no power should be provided to the electric motor 10 and that, instead, the regeneration circuit 30 should be used to recover any energy stored in a moving vehicle to use the electric motor 10 as a generator. Also, the brake interface 64 may operate a conventional mechanical brake (not shown in the drawings). While this description refers to automotive applications, the reader skilled in the art will really appreciate the electric motor 10 is also usable in other types of applications. In addition, the electric motor 10 is also usable as a generator.

The controller 22 is connected to the direction control 60, the accelerator interface 62 and the brake interface 64 to receive the signals emitted by the control interface 26 and suitably powering the power supply 24 to obtain a desired action. To that effect, the controller 22 is also connected to the power supply 24, which includes batteries and power electronics necessary for selectively transmitting electrical power from the batteries to the electric motor 10. Also, the power supply 24 is connected to the regeneration circuit 30 to be able to receive electrical power from the electric motor 10 when the electric motor 10 is used as a generator and recharges the batteries.

The power supply 24 selectivity powers the coils 34 to rotate the rotors 14 relatively to the stators of 16. To this effect, the angular position of the rotors 16 is provided to the controller 22 by the phase sensor 28. The phase sensor 28 is any conventional phase sensor, such as, for example, an optical encoder.

Each specific coil 34 is powered when the position of the rotor 14 is such that a rotational force exerted by each specific coil 34 is at least a predetermined percentage of the maximal force than can be exerted by this specific coil 34 onto an adjacent magnet in the rotors 16. In some embodiments of the invention, this percentage is about 50% of the maximum force, but other values are within the scope of the invention. In some embodiments of the invention, a coil 34 is either powered or not powered, but other power modulation schemes are also within the scope of the invention.

In some embodiments of the invention, the controller 22 is able to deactivate some of the stators 16 when only relatively low power is needed from the electric motor 10. This allows for conserving energy, which is of great importance in battery powered operation.

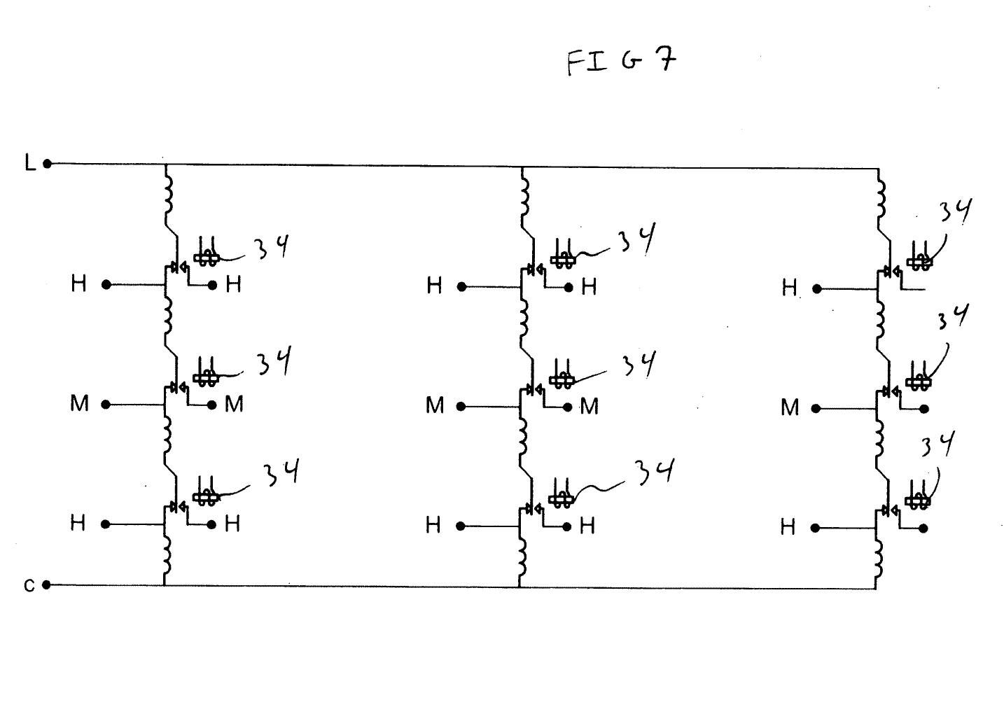

FIG. 7 illustrates the wiring of all the coils 34 of one of the stators 16. Wiring some of the coils 34 in series, for example by providing power between the C and L points, or by wiring the coils at least partially in parallel, for example by providing power between the L and C points and between the M and C points, or by providing power between all of the L, M, and H points and the C point, the impedance of the electric motor 10 can be varied. Selection of the impedance of the electric motor 10 is made by the controller 22 depending on the load exerted on the electric motor 10 and the rotation speed of the electric motor 10, among other possibilities. This selection is made according to conventional criteria and will therefore be described further details. The controller 22 is therefore operable for selectively conveying electric power alternatively in a parallel configuration and in a serial configuration, for example using solid state electronics. In the parallel configuration, a subset of coils 34 of each stator 16 are electrically coupled to each other connected in parallel, and, in the series configuration, the subset of coils 34 are electrically coupled to each other connected in series.

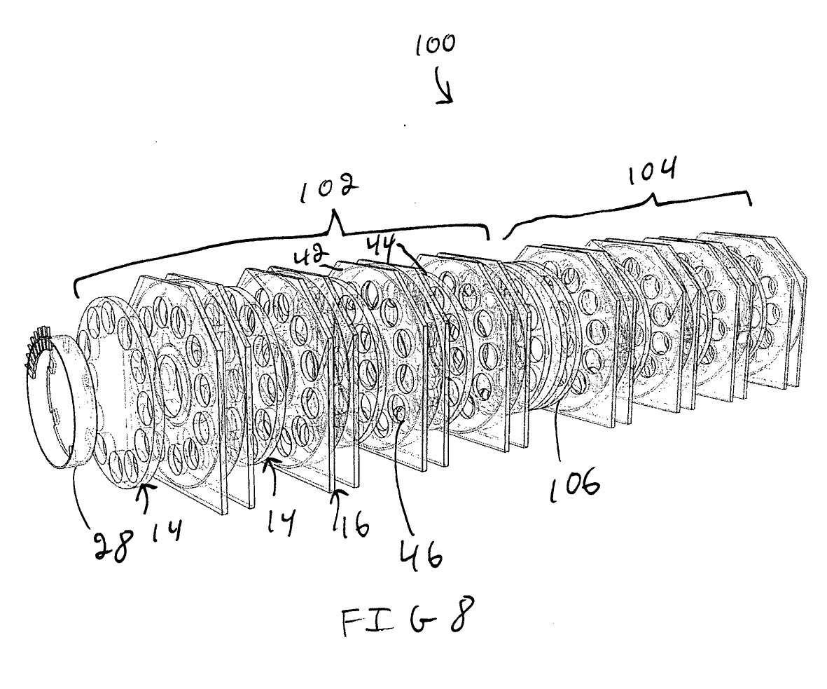

Referring to FIG. 8, there is shown an electric motor 100 in accordance with an alternative embodiment of the present invention. The electric motor 100 works substantially similarity to the electric motor 10. However, the electric motor 100 embodies the embodiment of the invention in which two sections of the electric motor 100 are operable substantially independently from each other while being coupled to each other to provide limited slip between the two sections of the electric motor 100.

More specifically, the electric motor 100 includes a motor first section 102 and a motor second section 104. The motor first and second sections 102 and 104 include stators 14 and rotors 16 as described hereinabove. However, instead of having a single axle 20 that interlinks all the rotors 16 to each other, the rotors 16 our divided into two subsets, each subset being included in a respective one of the motor first and second sections 102 when 104. The axles coupling the rotors 16 of each of the motor first and second sections 102 and 104 have been omitted from FIG. 8 for clarity reasons. The stators 14 and rotors 16 are nevertheless still substantially coaxial with each other.

A difference existing between the electric motor 100 and the electric motor 10 is that in the electric motor 100, the central stator 16 is omitted. Therefore, two rotors 16 face each other in the middle of the electric motor 100, each belonging to one of the motor first and second sections 102 and 104, without a stator 16 therebetween. These rotors 16 are substantially coaxial and face each other. These rotors 16 are rotatable independently from each other. However, they are magnetically coupled to each other so that rotation of a first one of the rotors 16 causes a rotation of the other one of the rotors 16. For example, the magnetic coupling is implemented by inserting a magnetic coupler 106 between these rotors 16. The magnetic coupler 106 includes a magnetically permeable material. For example, the magnetic coupler 106 is substantially plate shaped.

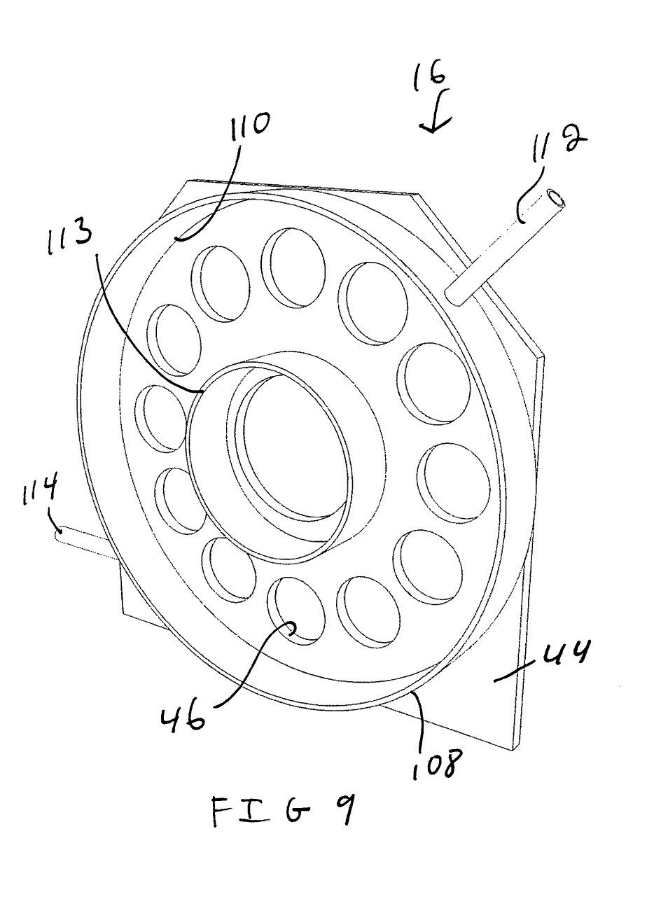

In some embodiments of the invention, the stator 16 of the electric motor 100 includes two substantially opposed stator end walls, embodied by the first and second plates 42 and 44, and a stator peripheral wall 108 extending there between substantially peripherally relatively to the coils 34 (which have been omitted from FIG. 8). The coils 34, as in the motor 10, extend between the stator end walls. The stator end walls and the stator peripheral wall 108 define an enclosure 110, better seen in FIG. 9. In some embodiments of the invention, a stator inner wall 113 is also provided at the periphery of the central aperture 38 and radially inwardly located with respect to the coils 34 and their recesses 46. In these embodiments, the enclosure 110 is therefore substantially annular.

In some embodiments of the invention, the stator 16 is provided with a fluid inlet 112 and the fluid outlet 114 leading respectively in an out of the enclosure 110 for allowing circulation of fluid in the enclosure 110. This configuration ensures optimal compact between the cooling fluid and the coils 34.

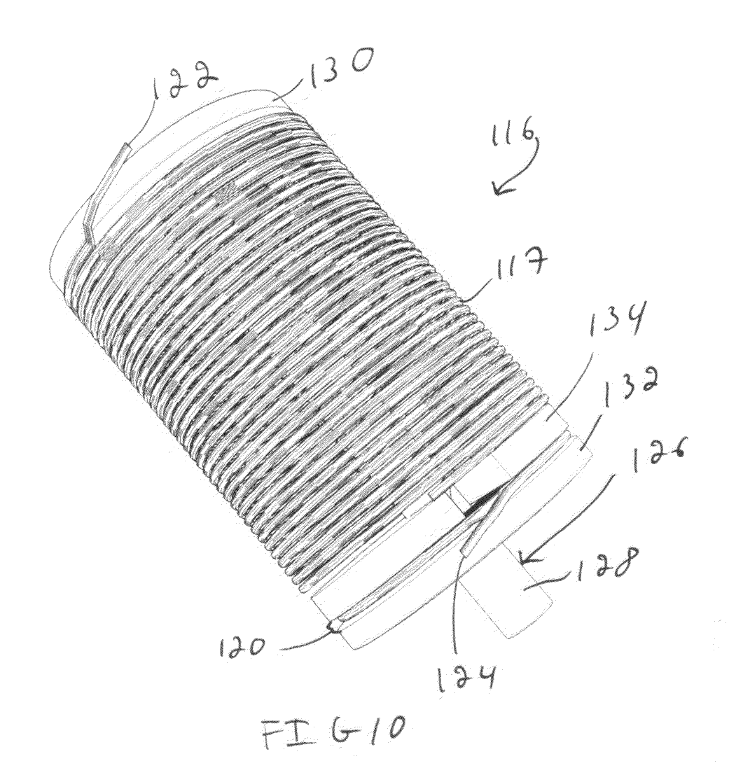

FIGS. 10 to 12 illustrates a coil 116 usable instead of the coil 34. The coil 116 is made out of substantially continuous insulated electrical wire 117. The coil 116 includes a coil first section 118 and a coil second section 120. The coil first and second sections 118 and 120 define respectively a first section coil end 122 and a second section coil end 124 to which electrical power can be provided. The first and second section coil ends 122 and 124 are provided on opposite ends of the electrical wire 117. The first and second section coil ends 122 and 124 are located radially outwardly with respect to the coil 116 and the coil 116 is substantially devoid of any substantially radially extending wire section. In other words, instead of manufacturing the coil 116 conventionally by winding up a wire around a mandrel, which results in one end of the wire arriving at a radially inwardly location in the coil 116, the coil 116 is manufactured differently. This configuration reduces the clutter of the radially inwardly directed wire, which is advantageous in many cases. Also, advantageously, the magnetic field created by the coil 116 in use is not crossed by the electrical wire 117.

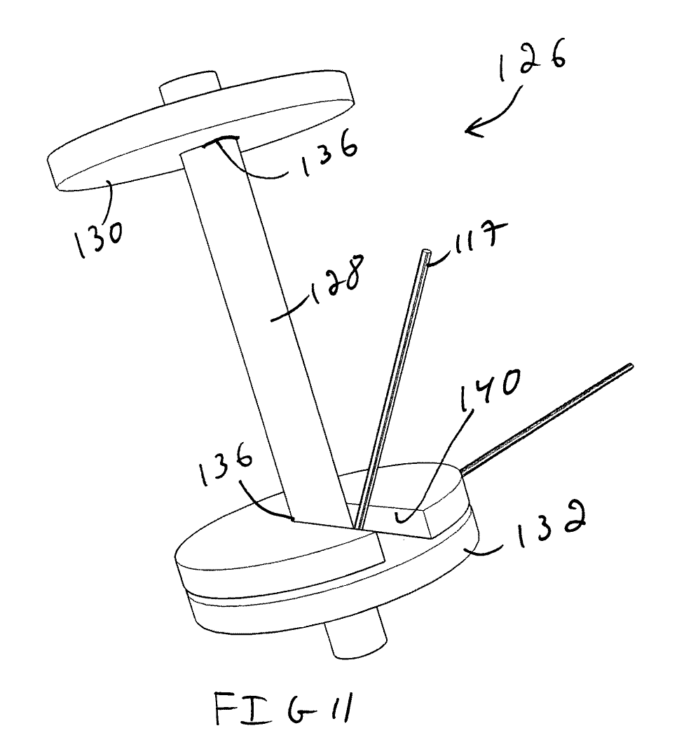

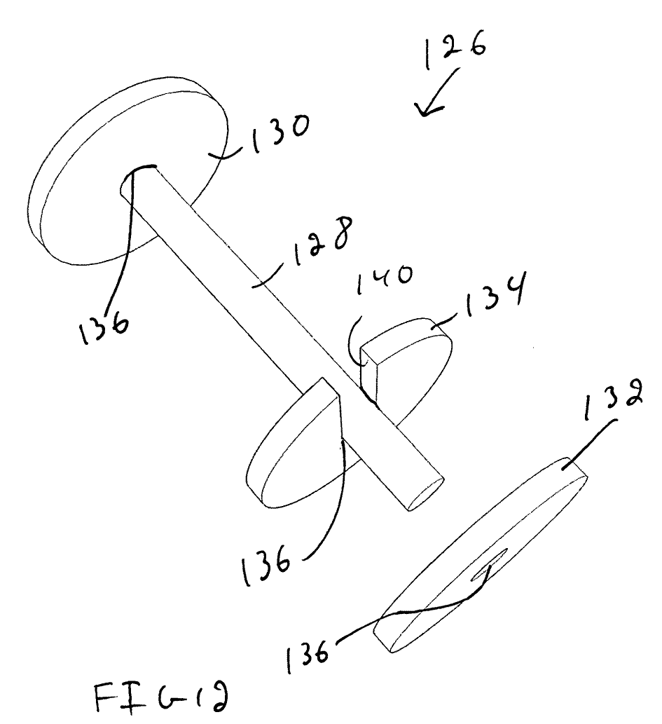

To manufacture the coil 116, a winding mandrel 126 as shown in the drawings is used. Referring to FIGS. 11 and 12, the winding mandrel 126 includes a central shaft 128 to which three delimiting elements 130, 132 and 134 are mounted. The delimiting elements 130, 132 and 134 are substantially disc-shaped and mounted in substantially axially spaced apart location on the central shaft 128. The delimiting elements 130 and 132 are mounted at the extremities of the coil 116 to manufacture. Each delimiting elements 130 and 132 and 134. define a central aperture 136 for mounting onto the central shaft 128. The delimiting element 134 is also substantially disc shaped but also defines a substantially radially extending recess 140 that extends from the periphery thereof to the central aperture 136. Therefore, the delimiting element 134 can be removed from the central shaft 128 through a substantially radial movement. The delimiting element 134 is inserted between the delimiting elements 130 and 132 and is provided between the coil first and second sections 118 and 120 during manufacturing.

Manufacturing of the coil 116 is made as follows. First, the electrical wire 117 is inserted through the recess 140 such that a section thereof abuts against the central shaft 128 and extends toward the space between the delimiting elements 130 and 132 in one direction and toward the space between delimiting elements 132 and 134 in the other direction. Then, the central shaft 128 is used to wind up two sections of the electrical wire 117 respectively between the delimiting element 130 and the delimiting element 134, and between the delimiting element 134 and the delimiting element 132, both in the same direction so that when an electrical current is passed through the electrical wire 117, the coil first and second sections 118 and 120 provide a magnetic field having the same polarity. When the coil 116 has been completely wound up, the ends of the electrical wire 117 are located radially peripherally with respect to the coil 116.

Although the present invention has been described hereinabove by way of preferred embodiments thereof, it can be modified, without departing from the spirit and nature of the subject invention as defined in the appended claims.

What is claimed is:

1. An electric motor, said electric motor comprising:
a motor first section, said motor first section including a first section stator, said first section stator including a plurality of coils disposed in a substantially annular configuration therearound, and a first section rotor, said first section rotor including a plurality of permanent magnets disposed in a substantially annular configuration therearound, said first section rotor being rotatable with respect to said first section stator;
a motor second section, said motor second section including a second section stator, said second section stator including a plurality of coils disposed in a substantially annular configuration therearound, and a second section rotor, said second section rotor including a plurality of permanent magnets disposed in a substantially annular configuration therearound, said second section rotor being rotatable with respect to said second section stator;
said first and second section rotors being substantially coaxial and facing each other, said first and second section rotors being rotatable independently from each other;
said first and second section rotors being magnetically coupled to each other so that a rotation of a first one of said first and second section rotors causes a rotation of the other one said first and second section rotor.

2. An electric motor as defined in claim 1, further comprising a magnetic coupler including a magnetically permeable material inserted between said first and second section rotors.

3. An electric motor as defined in claim 2, wherein said magnetic coupler is substantially plate-shaped.

4. An electric motor as defined in claim 1, wherein first section stator includes a pair of substantially parallel and substantially opposed stator end walls and a stator peripheral wall extending therebetween substantially peripherally relatively to said coils, said coils extending between said stator end walls, said stator end and peripheral walls defining an enclosure.

5. An electric motor as defined in claim 4; wherein said first section stator is provided with a fluid inlet and a fluid outlet leading respectively in and out of said enclosure for allowing circulation of fluid in said enclosure.

6. An electric motor as defined in claim 1, said electric motor being usable with an electric power source, said electric motor further comprising a controller electrically coupled to said coils of said first section stator for conveying electric power from said electric power source to said coils of said first section, said controller being operable for selectively conveying said electric power alternatively in a parallel configuration and in a serial configuration, wherein, in said parallel configurations, a subset of said coils are electrically coupled to each other connected in parallel, and, in said series configuration, said subset of said coils are electrically coupled to each other connected in series.

7. An electric motor as defines in claim 1, wherein at least one of said coils is made out of substantially continuous electrical wire and includes a coil first section and a coil second section, said coil first and second sections defining respectively a first section coil end to which electrical power can be provided and a second section coil end to which electrical power can be provided, said first and second section coil ends being located radially outwardly with respect to said at least one of said coils, said at least one of said coils being devoid of any substantially radially extending wire section.
